(19) United States
(12) Patent Application Publication
(10) Pub. No.: US 2017/0155955 A1
(43) Pub. Date: Jun. 1, 2017

(54) METHOD AND DEVICE FOR DISTINGUISHING USER DATA OF SMART TV

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventors: Shu Liu, Tianjin (CN); Lei Yan, Tianjin (CN)

(21) Appl. No.: 15/247,664

(22) Filed: Aug. 25, 2016

Related U.S. Application Data
(63) Continuation of application No. PCT/CN2016/089245, filed on Jul. 7, 2016.

(30) Foreign Application Priority Data
Dec. 1, 2015 (CN) 201510870439.4

(51) Int. Cl. H04N 21/4415; H04N 5/232; G06K 9/00; H04N 21/4223; H04N 21/45

(52) U.S. Cl. CPC H04N 21/4415; H04N 21/4223; H04N 21/4532; G06K 9/00228; H04N 5/232

(57) ABSTRACT

The embodiment of the present disclosure discloses a method and a device for distinguishing user data of a smart TV. The method comprises turning on the smart TV and starting a camera shooting device; performing face detection on the photo shot by the camera shooting device so as to acquire a face part photo; determining an identity of a user according to the face part photo when the face part photo comprises a single user; and controlling the smart TV to display an individual data record which corresponds to the identity of the user, and recording and storing a new data record when the individual data record which corresponds to the identity of the user changes.

### CROSS-REFERENCE TO RELATED APPLICATIONS

This application is a continuation of International Application No. PCT/CN2016/089245 filed on Jul. 7, 2016, which is based upon and claims priority to Chinese Patent Application No. 201510870439.4, filed Dec. 1, 2015, the entire contents of all of which are incorporated herein by reference.

### TECHNICAL FIELD

The disclosure generally discloses the technical field of household appliances and in particular discloses a method and a device for distinguishing user data of a smart TV.

### BACKGROUND

TV is used in thousands of homes nowadays, acquisition of information messages by watching TV has become a common living habit. However, TV is a piece of equipment used by the whole family, and due to different preferences of different people, data, such as film watching records, application downloads and the like, generated when users watch TV are different. At present, data of the TV generated to the users may not be distinguished, and the users have great trouble of searching the generated data.

In the prior art, the data is distinguished by switching login accounts of the users, however, the data distinguishing manner is relatively complicated to many TV users such as the old and children, the use is inconvenient, the users do not have such a using habit, and the user experience is low.

### SUMMARY

The embodiment of the present disclosure discloses a method for distinguishing user data of a smart TV, and for overcoming the defects in the prior art that use of the user is inconvenient and the user experience is low because the user needs to switch the login account so as to realize data distinguishing. Therefore, when the TV is used by a current user, the current user does not need to perform account switching, namely the individual data record of the current user be conveniently checked, and the user experience is greatly improved.

To solve the problem above, embodiments of the present disclosure discloses a method for distinguishing user data of a smart TV, comprising the following steps: turning on the smart TV and starting a camera shooting device; performing face detection on the photo shot by the camera shooting device so as to acquire a face part photo; determining an identity of a user according to the face part photo when the face part photo comprises a single user; and controlling the smart TV to display an individual data record which corresponds to the identity of the user, and recording and storing a new data record when the individual data rec

To solve the problem above, embodiments of the present disclosure further discloses an electronic device for distinguishing user data, including at least one processor; and a memory communicably connected with the at least one processor for storing instructions executable by the at least one processor, wherein execution of the instructions by the at least one processor causes the at least one processor to: turn on the electronic device and starting a camera shooting device; perform face detection on the photo shot by the camera shooting device so as to acquire a face part photo; determine an identity of a user according to the face part photo when the face part photo includes a single user; control the electronic device to display an individual data record which corresponds to the identity of the user, and recording and storing a new data record when the individual data record which corresponds to the identity of the user changes.

According to another aspect of the present disclosure, there is provided a computer program, including computer readable codes for executing the method for distinguishing user data of the smart TV above by computing device when the computer readable codes are operated on the computing device.

According to still another aspect of the present disclosure, there is provided a non-transitory computer readable medium storing executable instructions that, when executed by an electronic device, cause the electronic device to: turn on the electronic device and starting a camera shooting device at the same time; perform face detection on the photo shot by the camera shooting device so as to acquire a face part photo; determine an identity of a user according to the face part photo when the face part photo comprises a single user; control the electronic device to display an individual data record which corresponds to the identity of the user, and recording and storing a new data record when the individual data record which corresponds to the identity of the user changes.

According to the method and the device for distinguishing the user data of the smart TV provided by the embodiment of the present disclosure, after the smart TV is turned on and the camera shooting device is started, the photo shot by the camera shooting device is subjected to face detection so as to acquire a face part photo, an identity of the user is further determined according to the face part photo when the face part photo includes single users such as the old and children or other users, and finally, the smart TV is controlled to display an individual data record which corresponds to the identity of the user, and a new data record is recorded and stored when the individual data record which corresponds to the identity of the user changes. Therefore, the user does not need to perform account switching when the TV is used by the single users, and the individual data record of the user is automatically displayed, so that the data record is conveniently checked by the user, and the user experience is greatly improved.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 shows the flow chart of steps of a method for distinguishing user data of the smart TV in the embodiment of the present disclosure.

FIG. 2 shows the flow chart of steps of another method for distinguishing user data of the smart TV in the embodiment of the present disclosure.

FIG. 3 shows the structure diagram of a device for distinguishing user data of the smart TV in the embodiment of the present disclosure.

FIG. 4 shows the structure diagram of another device for distinguishing user data of the smart TV in the embodiment of the present disclosure.

FIG. 5 schematically shows a block diagram of an electronic device used for executing the method according to the embodiment of the present disclosure.

FIG. 6 schematically shows a storage unit used for keeping or carrying program codes for executing the method according to the embodiment of the present disclosure.

### DETAILED DESCRIPTION

To make the purposes, technical schemes and advantages of the embodiments of the present disclosure clearer, the technical schemes in the embodiments of the present disclosure are clearly and completely described with the following figures in the embodiments of the present disclosure, the described embodiments are not all but a part of the embodiments of the present disclosure. Based on the embodiments of the present disclosure, other embodiments obtained by a person skilled in the art of the field under the condition that no creative work is made all belong to the protection scope of the present disclosure.

### Embodiment I

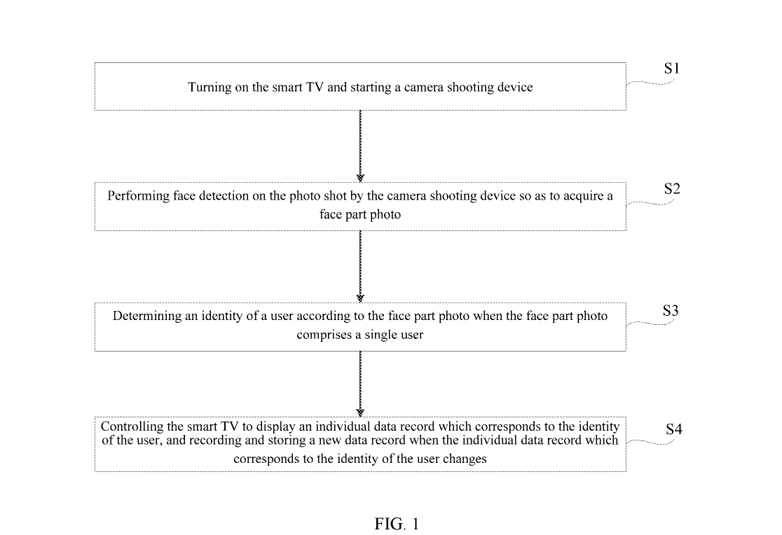

FIG. 1 shows the flow chart of steps of a method for distinguishing user data of the smart TV in the embodiment of the present disclosure.

The method for distinguishing user data of the smart TV in the embodiment of the present disclosure may include the steps as follows.

S1, turning on the smart TV and starting a camera shooting device.

Wherein after the camera shooting device is started in the S1, if the user enters an identification range of a camera of the camera shooting device, a photo of the user is shot by the camera shooting device.

S2, performing face detection on the photo shot by the camera shooting device so as to acquire a face part photo.

In S2, the shot photo may be pre-viewed and acquired from the camera bottom layer of the camera shooting device, and the face part photo is further intercepted after face detection.

S3, determining an identity of a user according to the face part photo when the face part photo includes a single user.

In S3, the number of users included in the face part photo may be determined according to the face part photo, wherein when the face part photo includes single users such as the old and children or other users, the identity of the user may be determined by cloud according to the face part photo in S3, thereby entering S4. It's important to note that the identity of the user is automatically established by account application of the smart TV, namely ID (Identity), or is established by the user in account application.

S4, controlling the smart TV to display an individual data record which corresponds to the identity of the user, and recording and storing a new data record when the individual data record which corresponds to the identity of the user changes.

The individual data records may include one or more of system message records, play records, purchase records, video chat records, video recommendation records or poster recommendation records, and also may include records of other users generated in the smart TV using process. Specifically, the new data record may be recorded and stored into a database of the smart TV in S4, wherein the new data record corresponds to the identity of the user.

Specifically, the smart TV may be controlled to only display the individual data record which corresponds to the identity of the user in S4, so that the user does not need to perform account switching, namely the individual data record may be conveniently checked, and the user experience is greatly improved.

In addition, when the individual data record which corresponds to the account of the user changes, the new data record may be automatically recorded and stored in S4, so that when the identity of the current user is determined in the next step S3, the new data record may be automatically displayed in S4.

According to the embodiment I of the present disclosure, after the smart TV is turned on and the camera shooting device is started, the photo shot by the camera shooting device is subjected to face detection so as to acquire a face part photo, an identity of the user is further determined according to the face part photo when the face part photo includes a single user, and finally, the smart TV is controlled to display an individual data record which corresponds to the identity of the user, and a new data record is recorded and stored when the individual data record which corresponds to the identity of the user changes. Therefore, the current user does not need to perform account switching when the TV is used by the single user, and the individual data record of the user is automatically displayed, so that the data record is conveniently checked by the user, and the user experience is greatly improved.

### Embodiment II

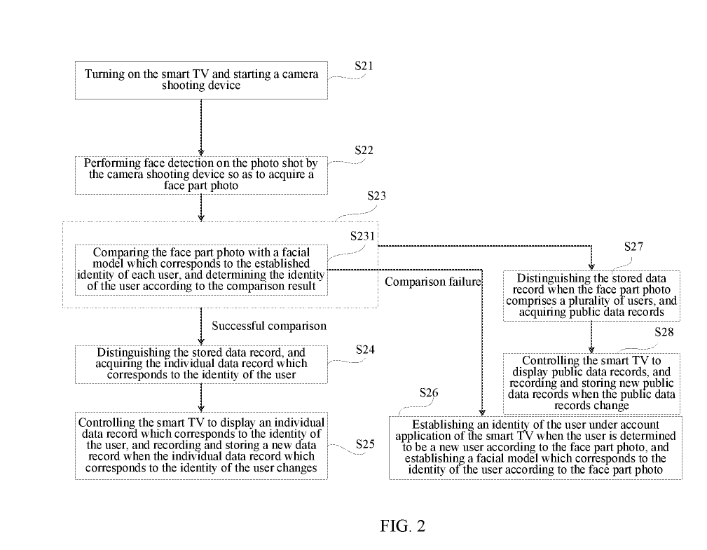

FIG. 2 shows the flow chart of steps of another method for distinguishing user data of the smart TV in the embodiment of the present disclosure. The method for distinguishing user data of the smart TV may include the steps as follows.

S21, turning on the smart TV and starting a camera shooting device.

Wherein after the camera shooting device is started in the S21, if the user enters an identification range of a camera of the camera shooting device, a photo of the user is shot by the camera shooting device.

S22, performing face detection on the photo shot by the camera shooting device so as to acquire a face part photo.

In S22, the shot photo may be pre-viewed and acquired from the camera bottom layer of the camera shooting device, and the face part photo is further intercepted after face detection.

S23, determining an identity of a user according to the face part photo when the face part photo includes a single user, including:

S231, comparing the face part photo with a facial model which corresponds to the established identity of each user, and determining the identity of the user according to the comparison result.

Specifically, in S23, the number of users included in the face part photo may be determined according to the face part photo, wherein when the face part photo includes single users such as the old and children or other users, entering S231, and when the face part photo includes a plurality of users, entering S27.

Specifically, the identity of the user may be determined by cloud according to the face part photo in S231, wherein when the comparison result is that the single used included in the face part photo is matched with one of the established facial models which correspond to the identity of each user, namely the comparison is successful, the identity of the user is determined to be the established identity of the user, entering S24; and when the comparison result is that the single used included in the face part photo is mismatched with the established facial model which corresponds to the identity of each user, namely the comparison fails, the user is determined to be a new user, entering S26.

S24, distinguishing the stored data record, and acquiring the individual data record which corresponds to the identity of the user.

Wherein the individual data records may include one or more of system message records, play records, purchase records, video chat records, video recommendation records or poster recommendation records, and also may include records of other users generated in the smart TV using process. Specifically, the stored data record may be distinguished according to the established identity of each user in S24, namely after distinguishing, the identity of each user has a corresponding individual data record.

S25, controlling the smart TV to display an individual data record which corresponds to the identity of the user, and recording and storing a new data record when the individual data record which corresponds to the identity of the user changes.

In S25, the smart TV may be controlled to automatically display the individual data record which corresponds to the identity of the user in front of all the public data records, or to only display the individual data record which corresponds to the identity of the user, so that the user does not need to perform account switching, namely the individual data record may be conveniently checked, for example, a film which has not been watched yet last week may be found, and the user experience is greatly improved. Specifically, the new data record may be recorded and stored into the database of the smart TV in S25, wherein the new data record corresponds to the identity of the user.

In addition, when the individual data record which corresponds to the account of the user changes, the new data record may be automatically recorded and stored in S25, so that when the identity of the current user is determined in the next step S23, the new data record may be further automatically displayed in S25.

S26, establishing an identity of the user under account application of the smart TV when the user is determined to be a new user according to the face part photo, and establishing a facial model which corresponds to the identity of the user according to the face part photo.

In S26, the identity of the user may be automatically established by the account application of the smart TV, namely account ID, or the identity of the user may be established by the user in the account application. It's important to note that in actual application, because the number of people using the smart TV in a family or other occasions often is limited, in order to avoid lots of invalid data in the database or avoid malicious program attack, the upper limit of a number of identities capable of being established by the user in the account application may be set to be 10.

S27, distinguishing the stored data record when the face part photo includes a plurality of users, and acquiring public data records.

Wherein the public data records may include one or more of public system message records, play records, purchase records, video chat records, video recommendation records or poster recommendation records, and also may include records of other multiple users generated in the smart TV using process. Specifically, the stored data record may be distinguished according to the established identity of each user in S27, namely the residual data records are public data records after distinguishing.

S28, controlling the smart TV to display the public data records, and recording and storing new public data records when the public data records change.

In S28, the smart TV may be controlled to only display the public data records so as to conveniently hide the individual data record; meanwhile, the generated public data records before may be conveniently checked by multiple users, and the user experience is good. Specifically, in S28, the new public data records may be recorded and stored into the database of the smart TV.

In addition, because when the public data records change, the new public data records may be automatically recorded in S28, when the face part photo is determined to include multiple users in the next step S23, the new public data records may be further automatically displayed in S28.

According to the embodiment II of the present disclosure, after the smart TV is turned on and the camera shooting device is started, the photo shot by the camera shooting device is subjected to face detection so as to acquire a face part photo, the face part photo is compared with the facial model which corresponds to the established identity of each user when the face part photo includes a single user, the identity of the user is determined according to the comparison result, the stored data record is further distinguished, and the individual data record which corresponds to the identity of the user is acquired, and finally, the smart TV is controlled to display an individual data record which corresponds to the identity of the user, and a new data record is recorded and stored when the individual data record which corresponds to the identity of the user changes. In addition, when the user is determined to be a new user according to the face part photo, the identity of the user is established under account application of the smart TV, and the facial model which corresponds to the identity of the user is established according to the face part photo. Additionally, when the face part photo includes multiple users, the stored data record is distinguished, public data records are acquired, the smart TV is further controlled to display the public data records, and when the public data records change, new public data records are recorded and stored. Therefore, when the TV is used by the single user, the user does not need to perform account switching, and the individual record of the user is automatically displayed, and when the TV is used by the multiple users and the individual data record is hidden, only the public data records are automatically displayed, the public data records may be conveniently checked by the multiple users, and the user experience is greatly improved.

### Embodiment III

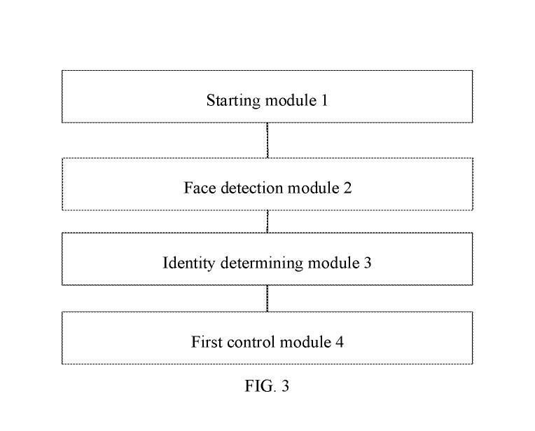

FIG. 3 shows the structure diagram of a device for distinguishing user data of the smart TV in the embodiment III of the present disclosure.

The device for distinguishing user data of the smart TV in the embodiment of the present disclosure may include:

a starting module 1, used for turning on the smart TV and starting a camera shooting device;

wherein after the camera shooting device is started by the starting module 1, if the user enters an identification range of a camera of the camera shooting device, a photo of the user is shot by the camera shooting device.

a face detection module 2, used for performing face detection on the photo shot by the camera shooting device so as to acquire a face part photo;

wherein the face detection module 2 may pre-view and acquire the shot photo from the camera bottom layer of the camera shooting device and further intercept the face part photo after face detection,

an identity determining module 3, used for determining an identity of a user according to the face part photo when the face part photo includes a single user.

The identity determining module 3 may determine the number of users included in the face part photo according to the face part photo, wherein when the face part photo includes single users such as the old and children or other users, the identity determining module 3 may determine the identity of the user by cloud according to the face part photo, entering a first control module 4. It's important to note that the identity of the user is automatically established by account application of the smart TV, namely account ID, or is established by the user in account application;

a first control module 4, used for controlling the smart TV to display an individual data record which corresponds to the identity of the user, and recording and storing a new data record when the individual data record which corresponds to the identity of the user changes;

wherein the individual data records may include one or more of system message records, play records, purchase records, video chat records, video recommendation records or poster recommendation records, and also may include records of other users generated in the smart TV using process. Specifically, the new data record may be recorded and stored into a database of the smart TV by the first control module 4, wherein the new data record corresponds to the identity of the user.

Specifically, the smart TV may be controlled to only display the individual data record which corresponds to the identity of the user by the first control module 4, so that the user does not need to perform account switching, namely the individual data record may be conveniently checked, and the user experience is greatly improved.

In addition, when the individual data record which corresponds to the account of the user changes, the new data record may be automatically recorded and stored by the first control module 4, so that when the identity of the current user is determined by the identity determining module 3 for the next time, the new data record may be automatically displayed by the first control module 4.

According to the embodiment III of the present disclosure, after the smart TV is turned on and the camera shooting device is started, the photo shot by the camera shooting device is subjected to face detection so as to acquire a face part photo, an identity of the user is further determined according to the face part photo when the face part photo includes a single user, and finally, the smart TV is controlled to display an individual data record which corresponds to the identity of the user, and a new data record is recorded and stored when the individual data record which corresponds to the identity of the user changes. Therefore, the current user does not need to perform account switching when the TV is used by the single user, and the individual data record of the user is automatically displayed, so that the data record is conveniently checked by the user, and the user experience is greatly improved.

### Embodiment IV

FIG. 4 shows the structure diagram of another device for distinguishing user data of the smart TV in the embodiment IV of the present disclosure. The device for distinguishing user data of the smart TV may include:

a starting module 41, used for turning on the smart TV and starting a camera shooting device;

wherein after the camera shooting device is started by the starting module 41, if the user enters an identification range of a camera of the camera shooting device, a photo of the user is shot by the camera shooting device.

a face detection module 42, used for performing face detection on the photo shot by the camera shooting device so as to acquire a face part photo;

wherein the face detection module 42 may pre-view and acquire the shot photo from the camera bottom layer of the camera shooting device and further intercept the face part photo after face detection;

an identity determining module 43, used for determining an identity of a user according to the face part photo when the face part photo includes a single user; including:

a comparison module 431, used for comparing the face part photo with a facial model which corresponds to the established identity of each user, and determining the identity of the user according to the comparison result.

Specifically, the number of users included in the face part photo may be determined by the determining module 43 according to the face part photo, wherein when the face part photo includes single users such as the old and children or other users, entering the comparison module 431, and when the face part photo includes a plurality of users, entering a public data record acquiring module 47.

Specifically, the identity of the user may be determined by cloud according to the face part photo by the comparison module 431, wherein when the comparison result is that the single used included in the face part photo is matched with one of the established facial models which correspond to the identity of each user, namely the comparison is successful, the identity of the user is determined to be the established identity of the user, entering an individual data record acquiring module 44; and when the comparison result is that the single used included in the face part photo is mismatched with the established facial model which corresponds to the identity of each user, namely the comparison fails, the user is determined to be a new user, entering an identity establishing module 46;

an individual data record acquiring module 44, used for distinguishing the stored data record, and acquiring the individual data record which corresponds to the identity of the user;

wherein the individual data records may include one or more of system message records, play records, purchase records, video chat records, video recommendation records or poster recommendation records, and also may include records of other users generated in the smart TV using process. Specifically, the stored data record may be distinguished according to the established identity of each user by the individual data record acquiring module 44, namely after distinguishing, the identity of each user has a corresponding individual data record;

a first control module 45, used for controlling the smart TV to display an individual data record which corresponds to the identity of the user, and recording and storing a new data record when the individual data record which corresponds to the identity of the user changes.

The first control module 45 may control the smart TV to automatically display the individual data record which corresponds to the identity of the user in front of all the public data records, or to only display the individual data record which corresponds to the identity of the user, so that the user does not need to perform account switching, namely the individual data record may be conveniently checked, for example, a film which has not been watched yet last week may be found, and the user experience is greatly improved. Specifically, the new data record may be recorded and stored into the database of the smart TV by the first control module 45, wherein the new data record corresponds to the identity of the user.

In addition, when the individual data record which corresponds to the account of the user changes, the new data record may be automatically recorded and stored by the first control module 45, so that when the identity of the current user is determined by the identity determining module 43 for the next time, the new data record may be further automatically displayed by the first control module 45;

an identity establishing module 46, used for establishing an identity of the user under account application of the smart TV when the user is determined to be a new user according to the face part photo, and establishing a facial model which corresponds to the identity of the user according to the face part photo.

wherein the identity establishing module 46 may automatically establish the identity of the user the account application of the smart TV, namely account ID, or the identity of the user may be established by the user in the account application. It's important to note that in actual application, because the number of people using the smart TV in a family or other occasions often is limited, in order to avoid lots of invalid data in the database or avoid malicious program attack, the upper limit of a number of identities capable of being established by the user in the account application may be set to be 10;

a public data record acquiring module 47, used for distinguishing the stored data record when the face part photo includes a plurality of users, and acquiring public data records.

wherein the public data records may include one or more of public system message records, play records, purchase records, video chat records, video recommendation records or poster recommendation records, and also may include records of other multiple users generated in the smart TV using process. Specifically, the stored data record may be distinguished according to the established identity of each user by the public data record acquiring module 47, namely the residual data records are public data records after distinguishing;

a second control module 48, controlling the smart TV to display the public data records, and recording and storing new public data records when the public data records change.

The second control module 48 may control the smart TV to only display the public data records so as to conveniently hide the individual data record; meanwhile, the generated public data records before may be conveniently checked by multiple users, and the user experience is good. Specifically, the new public data records may be recorded and stored into the database of the smart TV by the second control module 48.

In addition, because when the public data records change, the new public data records may be automatically recorded by the second control module 48, when the face part photo is determined to include multiple users in the identity determining module 43 for the next time, the new public data records may be further automatically displayed by the second control module 48.

According to the embodiment IV of the present disclosure, after the smart TV is turned on and the camera shooting device is started, the photo shot by the camera shooting device is subjected to face detection by the face detection module so as to acquire a face part photo, the face part photo is compared with the facial model which corresponds to the established identity of each user by the comparison module when the face part photo includes a single user, the identity of the user is determined according to the comparison result, the stored data record is further distinguished by the individual data record acquiring module, and the individual data record which corresponds to the identity of the user is acquired, and finally, the smart TV is controlled to display an individual data record which corresponds to the identity of the user by the first control module, and a new data record is recorded and stored when the individual data record which corresponds to the identity of the user changes. In addition, when the user is determined to be a new user according to the face part photo, the identity of the user is established under account application of the smart TV by the identity establishing module, and the facial model which corresponds to the identity of the user is established according to the face part photo. Additionally, when the face part photo includes multiple users, the stored data record is distinguished by the public data record acquiring module, public data records are acquired, the smart TV is further controlled to display the public data records by the second control module, and when the public data records change, new public data records are recorded and stored. Therefore, when the TV is used by the single user, the user does not need to perform account switching, and the individual record of the user is automatically displayed, and when the TV is used by the multiple users and the individual data record is hidden, only the public data records are automatically displayed, the public data records may be conveniently checked by the multiple users, and the user experience is greatly improved.

The device embodiments described above are schematic only, wherein units described as separate components may be or may not be separated physically; components which are adopted as display units display may be or may not be physical units, namely located on a place or distributed to a plurality of network units. The purpose of the schemes in the embodiment may be achieved via partial or all modules according to actual requirements. A person skilled in the art may understand and implement without creative labor.

Each of devices according to the embodiments of the disclosure may be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the modules in the device according to the embodiments of the disclosure. The disclosure may further be implemented as device program (for example, computer program and computer program product) for executing some or all of the methods as described herein. Such program for implementing the disclosure may be stored in the computer readable medium, or have a form of one or more signals. Such a signal may be downloaded from the internet websites, or be provided in carrier, or be provided in other manners.

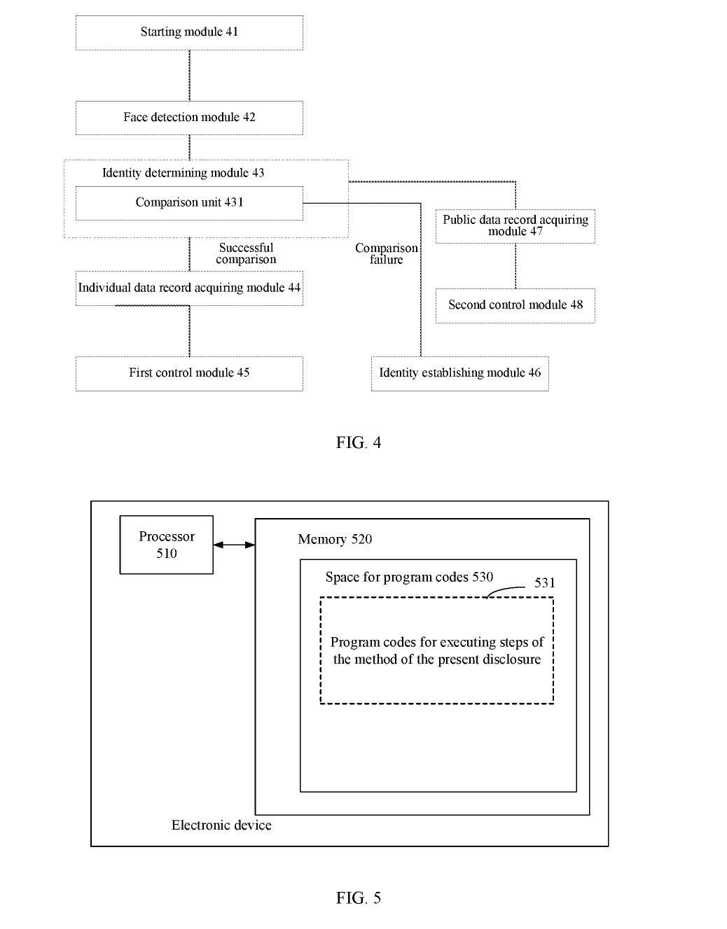

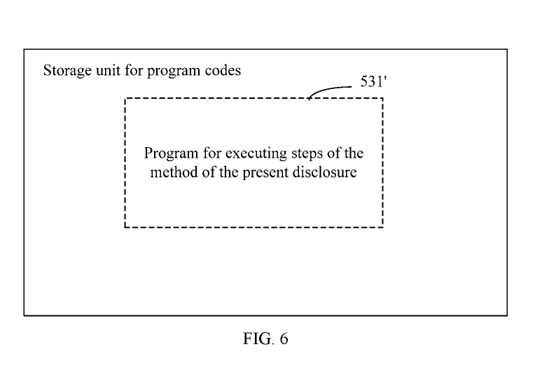

For example, FIG. 5 illustrates a block diagram of an electronic device for executing the method for distinguishing user data of a smart TV according the embodiment of the present disclosure. Traditionally, the electronic device includes a processor 510 and a computer program product or a computer readable medium in form of a memory 520. The memory 520 could be electronic memories such as flash memory, EEPROM (Electrically Erasable Programmable Read—Only Memory), EPROM, hard disk or ROM. The memory 520 has a memory space 530 for executing program codes 531 of any steps in the above methods. For example, the memory space 530 for program codes may include respective program codes 531 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 6. The memory cells may be provided with memory sections, memory spaces, etc., similar to the memory 520 of the electronic device as shown in FIG. 5. The program codes may be compressed for example in an appropriate form. Usually, the memory cell includes computer readable codes 531′ which may be read for example by processors 510. When these codes are operated on the electronic device, the electronic device may execute respective steps in the method as described above.

Through the description of the above embodiments, a person skilled in the art can clearly know that the embodiments can be implemented by software and necessary universal hardware platforms, or by hardware. Based on this understanding, the above solutions or contributions thereof to the prior art can be reflected in form of software products, and the computer software products can be stored in computer readable media, for example, ROM/RAM, magnetic discs, optical discs, etc., including various commands, which are used for driving a computer device (which may be a personal computer, a server or a network device) to execute methods described in all embodiments or in some parts of the embodiments.

Finally, it should be noted that the above embodiments are merely used to describe instead of limiting the technical solution of the present disclosure; although the above embodiments describe the present disclosure in detail, a person skilled in the art shall understand that they can modify the technical solutions in the above embodiments or make equivalent replacement of some technical characteristics of the present disclosure; those modifications or replacement and the corresponding technical solutions do not depart from the spirit and scope of the technical solutions of the above embodiments of the present disclosure.

What is claimed is:

1. A method for distinguishing user data of a smart TV, comprising the following steps:
turning on the smart TV and starting a camera shooting device;
performing face detection on the photo shot by the camera shooting device so as to acquire a face part photo;
determining an identity of a user according to the face part photo when the face part photo comprises a single user;
and controlling the smart TV to display an individual data record which corresponds to the identity of the user, and recording and storing a new data record when the individual data record which corresponds to the identity of the user changes.

2. The method according to the claim 1, further comprising:
controlling the smart TV to display public data records when the face part photo comprises a plurality of users, and recording and storing new public data records when the public data records change.

3. The method according to the claim 1, wherein the step of determining the identity of the user according to the face part photo comprises:
comparing the face part photo with a facial model which corresponds to the established identity of each user, and determining the identity of the user according to the comparison result.

4. The method according to the claim 1, before the step of controlling the smart TV to display the individual data record which corresponds to the identity of the user, further comprising:
distinguishing the stored data record, and acquiring the individual data record which corresponds to the identity of the user.

5. The method according to the claim 2, before controlling the smart TV to display the public data records, the method further comprising:
distinguishing the stored data record, and acquiring the public data records.

6. The method according to the claim 1, further comprising:
establishing an identity of the user under account application of the smart TV when the user is determined to be a new user according to the face part photo, and establishing a facial model which corresponds to the identity of the user according to the face part photo.

7. An electronic device for distinguishing user data, comprising:
at least one processor; and
a memory communicably connected with the at least one processor for storing instructions executable by the at least one processor, wherein execution of the instructions by the at least one processor causes the at least one processor to:
turn on the electronic device and starting a camera shooting device;
perform face detection on the photo shot by the camera shooting device so as to acquire a face part photo;
determine an identity of a user according to the face part photo when the face part photo comprises a single user;
control the electronic device to display an individual data record which corresponds to the identity of the user, and recording and storing a new data record when the individual data record which corresponds to the identity of the user changes.

8. The electronic device according to the claim 7, wherein execution of the instructions by the at least one processor further causes the at least one processor to:
control the electronic device to display public data records when the face part photo comprises a plurality of users, and record and store new public data records when the public data records change.

9. The electronic device according to the claim 7, wherein determine an identity of a user according to the face part photo when the face part photo comprises a single user comprises:
compare the face part photo with a facial model which corresponds to the established identity of each user, and determine the identity of the user according to the comparison result.

10. The electronic device according to the claim 7, wherein execution of the instructions by the at least one processor further causes the at least one processor to:
distinguish the stored data record, and acquire the individual data record which corresponds to the identity of the user.

11. The electronic device according to the claim 8, wherein execution of the instructions by the at least one processor causes the at least one processor to further:
distinguish the stored data record, and acquire the public data records.

12. The electronic device according to the claim 7, wherein execution of the instructions by the at least one processor causes the at least one processor to further:
establish an identity of the user under account application of the electronic device when the user is determined to be a new user according to the face part photo, and establish a facial model which corresponds to the identity of the user according to the face part photo.

13. A non-transitory computer readable medium storing executable instructions that, when executed by an electronic device, cause the electronic device to:
turn on the electronic device and starting a camera shooting device at the same time;
perform face detection on the photo shot by the camera shooting device so as to acquire a face part photo;
determine an identity of a user according to the face part photo when the face part photo comprises a single user;
control the electronic device to display an individual data record which corresponds to the identity of the user, and recording and storing a new data record when the individual data record which corresponds to the identity of the user changes.

14. The non-transitory computer readable medium according to the claim 13, wherein the electronic device is further caused to:
control the electronic device to display public data records when the face part photo comprises a plurality of users, and record and store new public data records when the public data records change.

15. The non-transitory computer readable medium according to the claim 13, wherein the electronic device is further caused to:
compare the face part photo with a facial model which corresponds to the established identity of each user, and determine the identity of the user according to the comparison result.

16. The non-transitory computer readable medium according to the claim 13, wherein the electronic device is further caused to:
distinguish the stored data record, and acquire the individual data record which corresponds to the identity of the user.

17. The non-transitory computer readable medium according to the claim 14, wherein the electronic device is further caused to:
distinguish the stored data record, and acquire the public data records.

18. The non-transitory computer readable medium according to the claim 13, wherein the electronic device is further caused to:
establish an identity of the user under account application of the electronic device when the user is determined to be a new user according to the face part photo, and establish a facial
model which corresponds to the identity of the user according to the face part photo.
